(19) United States
(12) Patent Application Publication
(10) Pub. No.: US 2018/0281779 A1
(43) Pub. Date: Oct. 4, 2018

(54) HYBRID VEHICLE, CONTROL DEVICE FOR HYBRID VEHICLE, AND CONTROL METHOD FOR HYBRID VEHICLE

(71) Applicant: TOYOTA JIDOSHA KABUSHIKI KAISHA, Toyota-shi (JP)

(72) Inventors: Daisuke ITOYAMA, Toyota-shi (JP); Shinichi SUGAI, Toyota-shi (JP)

(73) Assignee: TOYOTA JIDOSHA KABUSHIKI KAISHA, Toyota-shi (JP)

(21) Appl. No.: 15/941,639

(22) Filed: Mar. 30, 2018

(30) Foreign Application Priority Data
Apr. 4, 2017 (JP) 2017-074522

(51) Int. Cl. B60W 20/40; B60W 10/06; B60W 10/08; B60W 20/17

(52) U.S. Cl. CPC B60W 20/40; B60W 10/06; Y10S 903/93; B60W 20/17; B60W 2520/10; B60W 10/08

(57) ABSTRACT

A hybrid vehicle includes: an engine; a first motor configured to perform cranking of the engine; a second motor configured to receive or output power for traveling; an electricity storage device configured to supply electricity to the first motor and second motor or to be supplied with electricity from the first motor and the second motor; and an electronic control unit. The electronic control unit is configured to select, at an initiation stage of start-up of the engine, a damping map based on a vehicle speed at the start of cranking of the engine, from among a plurality of damping maps respectively corresponding to vehicle speeds set in advance to reduce vibration during the start-up of the engine. The electronic control unit is configured to control the first motor such that cranking of the engine is performed using the selected damping map until the start-up of the engine is completed.

### INCORPORATION BY REFERENCE

The disclosure of Japanese Patent Application No. 2017-074522 filed on Apr. 4, 2017 including the specification, drawings and abstract is incorporated herein by reference in its entirety.

### BACKGROUND

### 1. Technical Field

The disclosure relates to a hybrid vehicle, a control device for a hybrid vehicle, and a control method for a hybrid vehicle.

### 2. Description of Related Art

There is a hybrid vehicle including: an engine; a torque converter coupled to the engine and a drive shaft connected to drive wheels; a first motor configured to perform cranking of the engine (i.e., rotate a crankshaft of the engine); and a second motor configured to receive or output power for traveling (see, for example, Japanese Unexamined Patent Application Publication No. 2013-193613 (JP 2013-193613 A)). In the hybrid vehicle, during start-up of the engine, damping control is executed with the use of the first motor and the second motor in the following manner. When the speed ratio of the torque converter is low, the damping control is executed with the use of the first motor and the second motor such that the proportion of the damping control by the first motor is increased. On the other hand, when the speed ratio of the torque converter is high, the damping control is executed with the use of the first motor and the second motor such that the proportion of the damping control by the second motor is increased. Executing the damping control in this manner allows the damping effects to be efficiently achieved.

### SUMMARY

However, the hybrid vehicle described above still has room for improvement in the following respect. In the hybrid vehicle described above, the proportion between the damping control by the first motor and the damping control by the second motor is changed based on the speed ratio of the torque converter, in other words, based on the vehicle speed and the engine speed. Thus, when the proportion between the damping control by the first motor and the damping control by the second motor is changed, a shock may be given to the hybrid vehicle. Such a shock becomes a factor in deterioration of the comfort of occupants.

A hybrid vehicle, a control device for a hybrid vehicle, and a control method for a hybrid vehicle according to the disclosure reduce a shock that may be given to the vehicle during start-up of an engine.

The hybrid vehicle, the control device for a hybrid vehicle, and the control method for a hybrid vehicle according to the disclosure are configured as described below in order to reduce a shock that may be given to the vehicle during start-up of the engine.

A first aspect of the disclosure relates to a hybrid vehicle. The hybrid vehicle includes: an engine; a first motor configured to perform cranking of the engine; a second motor connected to a drive shaft; an electricity storage device configured to supply electricity to the first motor or to be supplied with electricity from the first motor, and configured to supply electricity to the second motor or to be supplied with electricity from the second motor; and an electronic control unit configured to control the engine, the first motor, and the second motor. The electronic control unit is configured to select, at an initiation stage of start-up of the engine, a damping map based on a vehicle speed at a start time of cranking of the engine, from among a plurality of damping maps respectively corresponding to vehicle speeds set in advance to reduce vibration during the start-up of the engine. The electronic control unit is configured to control the first motor such that cranking of the engine is performed using the selected damping map until the start-up of the engine is completed.

With this configuration, at the initiation stage of start-up of the engine, a damping map is selected based on a vehicle speed at the start time of cranking of the engine, from among the plurality of damping maps respectively corresponding to vehicle speeds set in advance to reduce vibration during the start-up of the engine. Further, the first motor is controlled such that cranking of the engine is performed using the selected damping map until the start-up of the engine is completed. In other words, the damping map is not changed until the start-up of the engine is completed. This makes it possible to prevent a shock due to a change in the damping map during start-up of the engine. As a result, it is possible to reduce a shock that may be given to the hybrid vehicle during start-up of the engine.

In the hybrid vehicle, a standstill-time damping map and a traveling-time damping map may be included in the plurality of damping maps. The standstill-time damping map is selected when the vehicle speed at the start time of cranking of the engine is lower than a threshold close to a value of zero. The traveling-time damping map is selected when the vehicle speed at the start time of cranking of the engine is equal to or higher than the threshold. This configuration is based on the finding that, while the hybrid vehicle is at a standstill, even a relatively small shock makes an occupant uncomfortable, whereas while the hybrid vehicle is traveling, a shock that occurs during start-up of the engine is less likely to make an occupant uncomfortable than when the hybrid vehicle is at a standstill.

In the hybrid vehicle, damping torque that is output while the standstill-time damping map is selected may be higher than damping torque that is output while the traveling-time damping map is selected.

In the hybrid vehicle, the electronic control unit may be configured to control the first motor such that cranking of the engine is performed using the standstill-time damping map until the start-up of the engine is completed, when the engine is started up while the hybrid vehicle is at a standstill.

A second aspect of the disclosure relates to a control device for a hybrid vehicle. The hybrid vehicle includes: an engine; a first motor configured to perform cranking of the engine; a second motor connected to a drive shaft; and an electricity storage device configured to supply electricity to the first motor or to be supplied with electricity from the first motor, and configured to supply electricity to the second motor or to be supplied with electricity from the second motor. The control device includes an electronic control unit configured to control the engine, the first motor, and the second motor. The electronic control unit is configured to select, at an initiation stage of start-up of the engine, a damping map based on a vehicle speed at a start time of cranking of the engine, from among a plurality of damping maps respectively corresponding to vehicle speeds set in advance to reduce vibration during the start-up of the engine. The electronic control unit is configured to control the first motor such that cranking of the engine is performed using the selected damping map until the start-up of the engine is completed.

With this configuration, at the initiation stage of start-up of the engine, a damping map is selected based on a vehicle speed at the start time of cranking of the engine, from among the plurality of damping maps respectively corresponding to vehicle speeds set in advance to reduce vibration during the start-up of the engine. Further, the first motor is controlled such that cranking of the engine is performed using the selected damping map until the start-up of the engine is completed. In other words, the damping map is not changed until the start-up of the engine is completed. This makes it possible to prevent a shock due to a change in the damping map during start-up of the engine. As a result, it is possible to reduce a shock that may be given to the hybrid vehicle during start-up of the engine.

A third aspect of the disclosure relates to a control method for a hybrid vehicle. The hybrid vehicle includes: an engine; a first motor configured to perform cranking of the engine; a second motor connected to a drive shaft; an electricity storage device configured to supply electricity to the first motor or to be supplied with electricity from the first motor, and configured to supply electricity to the second motor or to be supplied with electricity from the second motor; and an electronic control unit configured to control the engine, the first motor, and the second motor. The control method includes: selecting, by the electronic control unit, at an initiation stage of start-up of the engine, a damping map based on a vehicle speed at a start time of cranking of the engine, from among a plurality of damping maps respectively corresponding to vehicle speeds set in advance to reduce vibration during the start-up of the engine; and controlling, by the electronic control unit, the first motor such that cranking of the engine is performed using the selected damping map until the start-up of the engine is completed.

With this configuration, at the initiation stage of start-up of the engine, a damping map is selected based on a vehicle speed at the start time of cranking of the engine, from among the plurality of damping maps respectively corresponding to vehicle speeds set in advance to reduce vibration during the start-up of the engine. Further, the first motor is controlled such that cranking of the engine is performed using the selected damping map until the start-up of the engine is completed. In other words, the damping map is not changed until the start-up of the engine is completed. This makes it possible to prevent a shock due to a change in the damping map during start-up of the engine. As a result, it is possible to reduce a shock that may be given to the hybrid vehicle during start-up of the engine.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating the configuration of a hybrid vehicle according to an embodiment of the disclosure;

FIG. 2 is a flowchart illustrating an example of a damping map setting routine executed by an electronic control unit for a hybrid vehicle (HVECU);

FIG. 3 is a time-series chart schematically illustrating an example of a temporal change in the relationship among the cranking state, the vehicle speed, and the damping map; and

FIG. 4 is a diagram schematically illustrating the configuration of a hybrid vehicle in a modified example.

### DETAILED DESCRIPTION OF EMBODIMENTS

Hereinafter, example embodiments of the disclosure will be described with reference to the accompanying drawings.

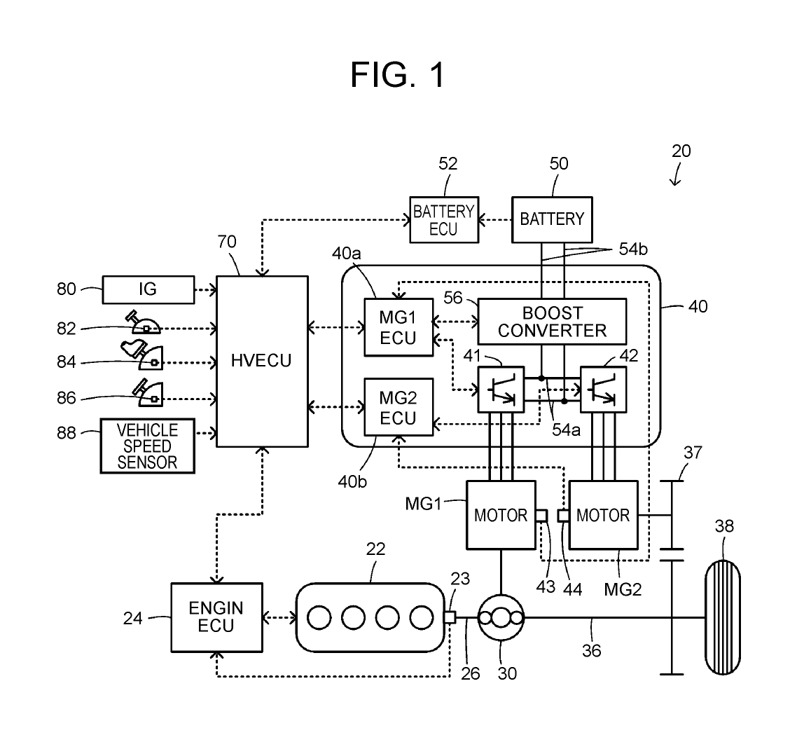

FIG. 1 is a diagram schematically illustrating the configuration of a hybrid vehicle 20 according to an embodiment of the disclosure. As illustrated in FIG. 1, the hybrid vehicle 20 according to the present embodiment includes an engine 22, a planetary gear mechanism 30, motors MG1, MG2, inverters 41, 42, a battery 50, a boost converter 56, and an electronic control unit 70 for a hybrid vehicle (hereinafter, referred to as “HVECU 70”).

The engine 22 is an internal combustion engine configured to generate power by burning fuel, such as gasoline or diesel oil. The operation of the engine 22 is controlled by an electronic control unit 24 for an engine (hereinafter, referred to as “engine ECU 24”).

Although not illustrated in the drawings, the engine ECU 24 is configured as a microprocessor including a central processing unit (CPU) as a main component. The engine ECU 24 includes, in addition to the CPU, a read-only memory (ROM) that stores processing programs, a random-access memory (RAM) that temporarily stores data, an input port, an output port, and a communication port. The engine ECU 24 receives, through the input port, signals from various sensors, which are required to control the operation of the engine 22, such as a signal indicating a crank angle θcr from a crank position sensor 23 that detects a rotational position of a crankshaft 26 of the engine 22. The engine ECU 24 outputs, through the output port, various control signals for controlling the operation of the engine 22. The engine ECU 24 is connected to the HVECU 70 through the communication port. The engine ECU 24 calculates a speed Ne of the engine 22 based on the crank angle θcr from the crank position sensor 23.

The planetary gear mechanism 30 is configured as a single-pinion planetary gear mechanism. The planetary gear mechanism 30 includes a sun gear connected to a rotor of the motor MG1. The planetary gear mechanism 30 includes a ring gear connected to a drive shaft 36 coupled to drive wheels 38. The planetary gear mechanism 30 includes a carrier connected to the crankshaft 26 of the engine 22 via a damper (not illustrated).

The motor MG1 is configured as, for example, a synchronous generator-motor. As described above, the rotor of the motor MG1 is connected to the sun gear of the planetary gear mechanism 30. The inverter 41 is connected to the battery 50 via the boost converter 56. The motor MG1 is rotationally driven as an electronic control unit 40a for a first motor (hereinafter, referred to as “MG1ECU 40a”) executes switching control on a plurality of switching elements (not illustrated) of the inverter 41.

The motor MG2 is configured as, for example, a synchronous generator-motor. The motor MG2 includes a rotor connected to the drive shaft 36 via a reduction gear 37. The inverter 42 is connected to the battery 50 via the boost converter 56. The motor MG2 is rotationally driven as an electronic control unit 40b for a second motor (hereinafter, referred to as “MG2ECU 40b”) executes switching control on a plurality of switching elements (not illustrated) of the inverter 42.

The boost converter 56 is configured as a well-known DC-DC converter including two transistors, two diodes, and a reactor, which are not illustrated. As the MG1ECU 40a executes switching control on the two transistors (not illustrated) of the boost converter 56, the boost converter 56 boosts the voltage of electricity from a battery-voltage-system power line 54b disposed on the battery 50-side and then supplies the electricity to a drive-voltage-system power line 54a disposed on the inverters 41, 42-side, or steps down the voltage of electricity from the drive-voltage-system power line 54a and then supplies the electricity to the battery-voltage-system power line 54b.

Although not illustrated in the drawings, the MG1ECU 40a is configured as a microprocessor including a central processing unit (CPU) as a main component. The MG1ECU 40a includes, in addition to the CPU, a read-only memory (ROM) that stores processing programs, a random-access memory (RAM) that temporarily stores data, an input port, an output port, and a communication port. The MG1ECU 40a receives, through the input port, signals from various sensors, which are required to control the driving of the motor MG1, such as a signal indicating a rotational position θm1 from a rotational position detection sensor 43 that detects a rotational position of the rotor of the motor MG1, and signals indicating phase currents Iu1, Iv1 and the like from current sensors (not illustrated). The phase currents are applied to the motor MG1 from the inverter 41. The MG1ECU 40a also receives, through the input port, a signal indicating a drive-voltage-system voltage VH from a voltmeter (not illustrated) attached to the drive-voltage-system power line 54a, and a signal indicating a battery-voltage-system voltage VL from a voltmeter (not illustrated) attached to the battery-voltage-system power line 54b. The MG1ECU 40a outputs, through the output port, signals, such as switching control signals to the switching elements (not illustrated) of the inverter 41, and a switching control signal to the boost converter 56. The MG1ECU 40a is connected to the HVECU 70 through the communication port. The MG1ECU 40a calculates a rotation speed Nm1 of the motor MG1 based on the rotational position θm1 of the rotor of the motor MG1, which is provided from the rotational position detection sensor 43.

Although not illustrated in the drawings, the MG2ECU 40b is configured as a microprocessor including a central processing unit (CPU) as a main component. The MG2ECU 40b includes, in addition to the CPU, a read-only memory (ROM) that stores processing programs, a random-access memory (RAM) that temporarily stores data, an input port, an output port, and a communication port. The MG2ECU 40b receives, through the input port, signals from various sensors, which are required to control the driving of the motor MG2, such as a signal indicating a rotational position θm2 from a rotational position detection sensor 44 that detects a rotational position of the rotor of the motor MG2, and signals indicating phase currents Iu2, Iv2 and the like from current sensors (not illustrated). The phase currents are applied to the motor MG2 from the inverter 42. The MG2ECU 40b also receives, through the input port, signals indicating a drive-voltage-system voltage VH from the voltmeter (not illustrated) attached to the drive-voltage-system power line 54a. The MG2ECU 40b outputs, through the output port, for example, switching control signals to the switching elements (not illustrated) of the inverter 42. The MG2ECU 40b is connected to the HVECU 70 through the communication port. The MG2ECU 40b calculates a rotation speed Nm2 of the motor MG2 based on the rotational position θm2 of the rotor of the motor MG2, which is provided from the rotational position detection sensor 44.

In the present embodiment, the MG1ECU 40a, the MG2ECU 40b, the inverters 41, 42, and the boost converter 56 are housed in a single case, and are collectively referred to as a power control unit 40 (hereinafter “PCU 40”).

The battery 50 is configured as, for example, a lithium-ion secondary battery or a nickel-hydride secondary battery. The battery 50 is connected to the inverters 41, 42 via the boost converter 56 as described above. The battery 50 is managed by an electronic control unit 52 for a battery (hereinafter, referred to as “battery ECU 52”).

Although not illustrated, the battery ECU 52 is configured as a microprocessor including a central processing unit (CPU) as a main component. The battery ECU 52 includes, in addition to the CPU, a read-only memory (ROM) that stores processing programs, a random-access memory (RAM) that temporarily stores data, an input port, an output port, and a communication port. The battery ECU 52 receives, through the input port, signals from various sensors, which are required to manage the battery 50, such as a signal indicating a battery voltage Vb from a voltage sensor (not illustrated) disposed between terminals of the battery 50, and a signal indicating a battery current Ib from a current sensor (not illustrated) attached to the output terminal of the battery 50. The battery ECU 52 is connected to the HVECU 70 through the communication port. The battery ECU 52 calculates a state of charge SOC based on an integrated value of the battery current Ib from the current sensor (not illustrated). The state of charge SOC means the ratio of the electricity dischargeable from the battery 50 to the total capacity of the battery 50.

Although not illustrated, the HVECU 70 is configured as a microprocessor including a central processing unit (CPU) as a main component. The HVECU 70 includes, in addition to the CPU, a read-only memory (ROM) that stores processing programs, a random-access memory (RAM) that temporarily stores data, a flash memory, an input port, an output port, and a communication port. The HVECU 70 receives signals from various sensors through the input port. Examples of the signals input into the HVECU 70 include an ignition signal from an ignition switch 80, a signal indicating a shift position SP from a shift position sensor 82, a signal indicating an accelerator operation amount Acc from an accelerator pedal position sensor 84, a signal indicating a brake pedal position BP from a brake pedal position sensor 86, and a signal indicating a vehicle speed V from a vehicle speed sensor 88. The HVECU 70 outputs various control signals through the output port. As described before, the HVECU 70 is connected to the engine ECU 24, the MG1ECU 40a, the MG2ECU 40b, and the battery ECU 52 through the communication port.

The hybrid vehicle 20 having the foregoing configuration in the present embodiment performs hybrid traveling (HV traveling) or electric traveling (EV traveling) in a charge depleting (CD) mode or a charge maintaining (CS) mode. The CD mode is a mode in which the state of charge SOC of the battery 50 is reduced. The CS mode is a mode in which the state of charge SOC of the battery 50 is maintained within a range centered at a control center SOC*.

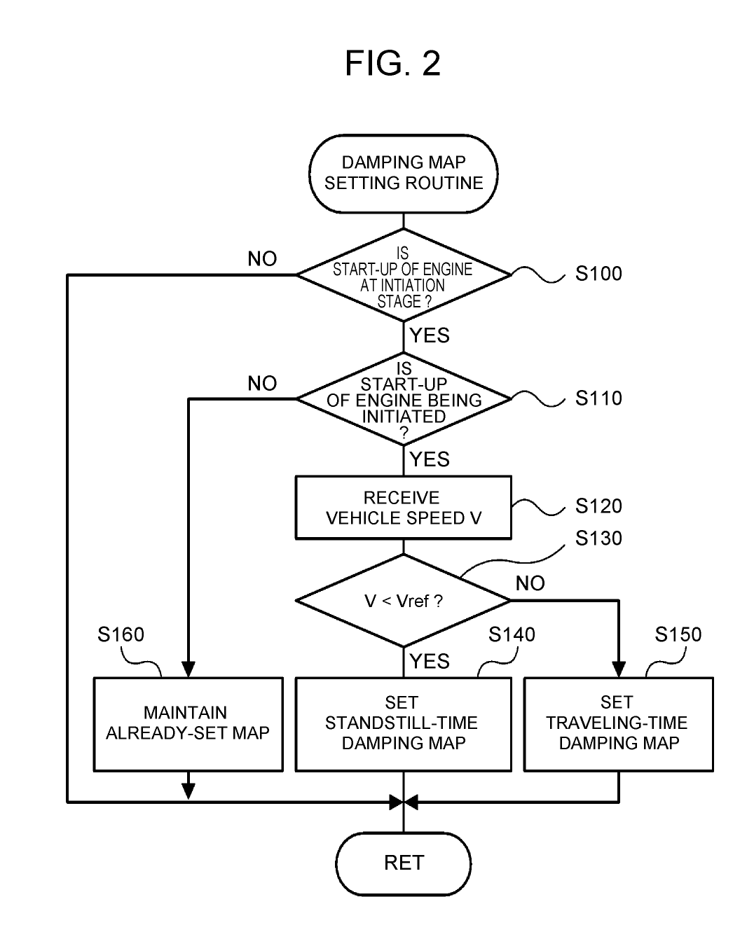

Next, description will be provided on the operation of the hybrid vehicle 20 according to the present embodiment, and provided particularly on the operation during start-up of the engine 22 when the hybrid vehicle 20 shifts from EV traveling to HV traveling. Start-up of the engine 22 is performed in the following manner: the crankshaft 26 of the engine 22 is rotated by outputting cranking torque from the motor MG1 and cancelling, by the motor MG2, the torque to be output toward the drive wheels 38 due to the output of the cranking torque (i.e., cranking of the engine 22 is performed); and fuel injection control and ignition control are started when the speed of the engine 22 reaches a prescribed speed. At this time, the motor MG1 outputs, in addition to the cranking torque, damping torque for reducing the vibration during start-up of the engine 22. That is, the motor MG1 outputs the torque that is the sum of the cranking torque and the damping torque. The damping torque is set in advance through experiment or the like, as the torque for cancelling the vibration during start-up of the engine 22. The damping torque is stored as damping maps. In the present embodiment, the damping maps include a standstill-time damping map that is used when the engine 22 is started up while the hybrid vehicle 20 is at a standstill, and a traveling-time damping map that is used when the engine 22 is started up while the hybrid vehicle 20 is traveling. In this way, the damping map is changed depending on whether the hybrid vehicle 20 is at a standstill or is traveling. This is based on the finding that, when the engine 22 is started up while the hybrid vehicle 20 is at a standstill, even a relatively small vibration makes an occupant uncomfortable, whereas when the engine 22 is started up while the hybrid vehicle 20 is traveling, an occupant does not feel uncomfortable until the magnitude of vibration exceeds a certain level. FIG. 2 is a flowchart illustrating an example of a damping map setting routine executed by the HVECU 70. The routine is repeatedly executed at prescribed time intervals (for example, at time intervals of several tens of milliseconds) until the start-up of the engine 22 is completed.

When the damping map setting routine is started, the HVECU 70 first determines whether the engine 22 is being started up (step S100). When the HVECU 70 determines that the engine 22 is not being started up, the HVECU 70 determines that it is not necessary to set the damping map used during start-up of the engine 22, and ends the present routine.

On the other hand, when the HVECU 70 determines in step S100 that the engine 22 is being started up, the HVECU 70 determines whether the start-up of the engine 22 is at the initiation stage (step S110). The determination can be made based on whether the determination in step S110 as to whether the start-up of the engine 22 is at the initiation stage is executed for the first time after the HVECU 70 determines in step S100 that the engine 22 is being started up. When the HVECU 70 determines that the start-up of the engine 22 is at the initiation stage, the HVECU 70 receives a vehicle speed V from the vehicle speed sensor 88 (step S120), and then determines whether the received vehicle speed V is lower than a threshold Vref (step S130). The threshold Vref is used to determine whether the hybrid vehicle 20 is in one of a state where the hybrid vehicle 20 is at a standstill and a state where the hybrid vehicle 20 is traveling at a considerably low vehicle speed. As the threshold Vref, for example, 3 km/h, 5 km/h, or 7 km/h may be used. When the HVECU 70 determines that the vehicle speed V is lower than the threshold Vref, the HVECU 70 sets the standstill-time damping map as the damping map used during the start-up of the engine 22 (step S140), and ends the present routine. On the other hand, when the HVECU 70 determines that the vehicle speed V is equal to or higher than the threshold Vref, the HVECU 70 sets the traveling-time damping map as the damping map used during the start-up of the engine 22 (step S150), and ends the present routine.

When the HVECU 70 determines in step S110 that the start-up of the engine 22 is not at the initiation stage, that is, the engine 22 is being started up but the start-up of the engine 22 is not at the initiation stage, the HVECU 70 maintains the damping map that is set when the HVECU 70 determines that the start-up of the engine 22 is at the initiation stage (step S160), and ends the present routine. That is, when the standstill-time damping map is set as the damping map at the initiation stage of the start-up of the engine 22, the standstill-time damping map is used as the damping map, irrespective of the vehicle speed V thereafter, until the start-up of the engine 22 is completed. When the traveling-time damping map is set as the damping map at the initiation stage of the start-up of the engine 22, the traveling-time damping map is used as the damping map, irrespective of the vehicle speed V thereafter, until the start-up of the engine 22 is completed.

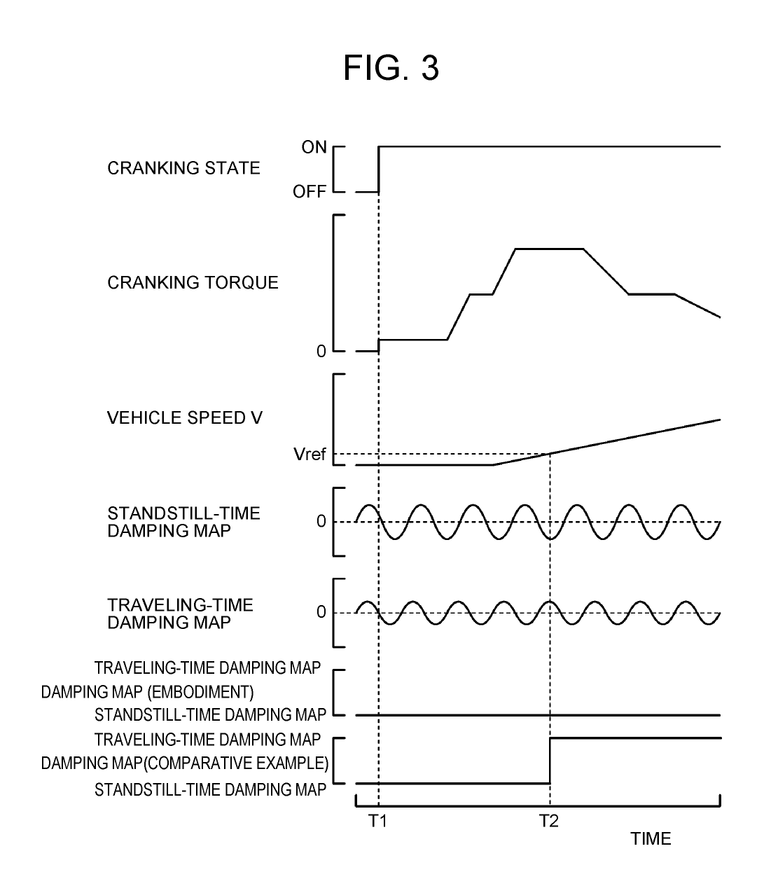

FIG. 3 is a time-series chart schematically illustrating an example of a temporal change in the relationship among the cranking state, the vehicle speed V, and the damping map. FIG. 3 illustrates, in the order from the top, temporal changes in the cranking state (ON/OFF), the cranking torque, the vehicle speed V, the standstill-time damping map (torque change), the traveling-time damping map (torque change), the state of setting of the damping map in the present embodiment, and the state of setting of the damping map in a comparative example. The standstill-time damping map and the traveling-time damping map are schematically illustrated to facilitate the description. In the comparative example, the damping maps are switched depending on the vehicle speed V during start-up of an engine. At time T1 at which cranking is started, the vehicle speed V is lower than the threshold Vref. Thus, both in the present embodiment and the comparative example, the standstill-time damping map is set as the damping map. Then, at time T2 at which the vehicle speed V becomes equal to or higher than the threshold Vref, the damping map is not changed and the standstill-time damping map is maintained as the damping map in the present embodiment. In the comparative example, the damping map is changed from the standstill-time damping map to the traveling-time damping map at time T2. Thus, in the comparative example, the damping torque is changed from the torque in the standstill-time damping map to the torque in the traveling-time damping map at time T2. Due to the torque difference, a shock is given to the hybrid vehicle 20. On the other hand, in the present embodiment, the standstill-time damping map set at time T1 at which start-up of the engine 22 is initiated is used as the damping map until the start-up of the engine 22 is completed. As a result, a shock due to a change in the damping map is no longer given to the hybrid vehicle 20. FIG. 3 illustrates a case where start-up of the engine 22 is initiated while the vehicle is at a standstill and the vehicle speed V reaches a value equal to or higher than the threshold Vref before the start-up of the engine 22 is completed. In a case where start-up of the engine 22 is initiated while the hybrid vehicle 20 is traveling at a vehicle speed equal to or higher than the threshold Vref and the vehicle speed V becomes lower than the threshold before the start-up of the engine 22 is completed, the standstill-time damping map and the traveling-time damping map are just exchanged.

In the hybrid vehicle 20 according to the present embodiment described above, during start-up of the engine 22, the standstill-time damping map is set as the damping map when the vehicle speed V at the initiation stage of the start-up of the engine 22 is lower than the threshold Vref, whereas when the vehicle speed V is equal to or higher than the threshold Vref, the traveling-time damping map is set as the damping map. Until the start-up of the engine 22 is completed, the set damping map is maintained irrespective of the vehicle speed V. This makes it possible to avoid a situation where a shock is given to the hybrid vehicle 20 due to a change in the damping map during start-up of the engine 22. As a result, it is possible to reduce a shock that may be given to the hybrid vehicle 20 during start-up of the engine 22.

In the hybrid vehicle 20 according to the present embodiment, the standstill-time damping map is set as the damping map when the vehicle speed V at the initiation stage of start-up of the engine 22 is lower than the threshold Vref, whereas the traveling-time damping map is set as the damping map when the vehicle speed V at the initiation stage of start-up of the engine 22 is equal to or higher than the threshold Vref. Alternatively, a plurality of traveling-time damping maps may be prepared, and when the vehicle speed V is equal to or higher than the threshold Vref, a damping map corresponding to the vehicle speed V may be selected from the plurality of traveling-time damping maps and may be set as the damping map. In this case, the standstill-time damping map may be set only when the vehicle speed V is a value of zero.

In the hybrid vehicle 20 according to the present embodiment, the battery 50 is used as an electricity storage device. However, any devices configured to store electricity, such as a capacitor, may be used as an electricity storage device.

The hybrid vehicle 20 according to the present embodiment includes the engine ECU 24, the MG1ECU 40a, the MG2ECU 40b, the battery ECU 52, and the HVECU 70. Alternatively, the engine ECU 24, the MG1ECU 40a, the MG2ECU 40b, the battery ECU 52, and the HVECU 70 may be integrated into a single electronic control unit.

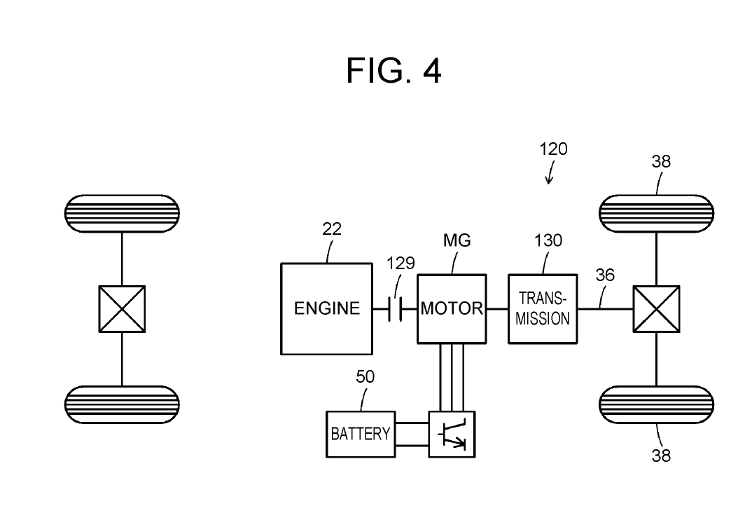

The hybrid vehicle 20 according to the present embodiment is configured such that the engine 22 and the motor MG1 are coupled via the planetary gear mechanism 30 to the drive shaft 36 connected to the drive wheels 38, and the motor MG2 is coupled to the drive shaft 36. Alternatively, for example, a so-called series-hybrid vehicle in which an engine is connected to an electric generator and a motor is connected to a drive shaft may be employed. Also, a hybrid vehicle 120 in a modified example in FIG. 4 may be employed. The hybrid vehicle 120 is configured such that a motor MG is coupled via a transmission 130 to a drive shaft 36 connected to drive wheels 38 and an engine 22 is coupled via a clutch 129 to a rotary shaft of the motor MG. In the hybrid vehicle 120 in FIG. 4, when cranking of the engine 22 is performed by a starter motor (not illustrated), the starter motor corresponds to the motor MG1 in the foregoing embodiment. When cranking of the engine 22 is performed by the motor MG, the motor MG serves as both the motor MG1 and the motor MG2 in the foregoing embodiment.

Next, description will be provided on the correspondence relationship between the main elements in the foregoing embodiment and the main elements described in Summary. The engine 22 in the foregoing embodiment is an example of “engine” in Summary, the motor MG1 in the foregoing embodiment is an example of “first motor” in Summary, the motor MG2 in the foregoing embodiment is an example of “second motor” in Summary, the battery 50 in the foregoing embodiment is an example of “electricity storage device” in Summary, and the HVECU 70, the engine ECU 24, and the motor ECU 40 are collectively an example of “electronic control unit” in Summary.

The foregoing embodiment is one example for concretely describing a mode for carrying out the disclosure described in Summary. Therefore, the correspondence relationship between the main elements in the foregoing embodiment and the main elements described in Summary is not intended to limit the elements of the disclosure described in Summary. That is, the disclosure described in Summary should be interpreted based on the description in Summary, and the forgoing embodiment is merely one example of the disclosure described in Summary.

While one example embodiment of the disclosure has been described above, the disclosure is not limited to the foregoing example embodiment, and the disclosure may be implemented in various other embodiments within the scope of the disclosure.

The disclosure is applicable to, for example, the industry for manufacturing hybrid vehicles.

What is claimed is:

1. A hybrid vehicle comprising:
an engine;
a first motor configured to perform cranking of the engine;
a second motor connected to a drive shaft;
an electricity storage device configured to supply electricity to the first motor or to be supplied with electricity from the first motor, and configured to supply electricity to the second motor or to be supplied with electricity from the second motor; and
an electronic control unit configured to control the engine, the first motor, and the second motor,
the electronic control unit being configured to select, at an initiation stage of start-up of the engine, a damping map based on a vehicle speed at a start time of cranking of the engine, from among a plurality of damping maps respectively corresponding to vehicle speeds set in advance to reduce vibration during the start-up of the engine, and the electronic control unit being configured to control the first motor such that cranking of the engine is performed using the selected damping map until the start-up of the engine is completed.

2. The hybrid vehicle according to claim 1, wherein:
a standstill-time damping map and a traveling-time damping map are included in the plurality of damping maps; and
the standstill-time damping map is selected when the vehicle speed at the start time of cranking of the engine is lower than a threshold close to a value of zero, and the traveling-time damping map is selected when the vehicle speed at the start time of cranking of the engine is equal to or higher than the threshold.

3. The hybrid vehicle according to claim 2, wherein damping torque that is output while the standstill-time damping map is selected is higher than damping torque that is output while the traveling-time damping map is selected.

4. The hybrid vehicle according to claim 2, wherein the electronic control unit is configured to control the first motor such that cranking of the engine is performed using the standstill-time damping map until the start-up of the engine is completed, when the engine is started up while the hybrid vehicle is at a standstill.

5. A control device for a hybrid vehicle, the hybrid vehicle including: an engine; a first motor configured to perform cranking of the engine; a second motor connected to a drive shaft; and an electricity storage device configured to supply electricity to the first motor or to be supplied with electricity from the first motor, and configured to supply electricity to the second motor or to be supplied with electricity from the second motor,
the control device comprising an electronic control unit configured to control the engine, the first motor, and the second motor,
the electronic control unit being configured to select, at an initiation stage of start-up of the engine, a damping map based on a vehicle speed at a start time of cranking of the engine, from among a plurality of damping maps respectively corresponding to vehicle speeds set in advance to reduce vibration during the start-up of the engine, and the electronic control unit being configured to control the first motor such that cranking of the engine is performed using the selected damping map until the start-up of the engine is completed.

6. A control method for a hybrid vehicle, the hybrid vehicle including: an engine; a first motor configured to perform cranking of the engine; a second motor connected to a drive shaft; an electricity storage device configured to supply electricity to the first motor or to be supplied with electricity from the first motor, and configured to supply electricity to the second motor or to be supplied with electricity from the second motor; and an electronic control unit configured to control the engine, the first motor, and the second motor,
the control method comprising:
selecting, by the electronic control unit, at an initiation stage of start-up of the engine, a damping map based on a vehicle speed at a start time of cranking of the engine, from among a plurality of damping maps respectively corresponding to vehicle speeds set in advance to reduce vibration during the start-up of the engine; and
controlling, by the electronic control unit, the first motor such that cranking of the engine is performed using the selected damping map until the start-up of the engine is completed.
